(19) United States
(12) Patent Application Publication
(10) Pub. No.: US 2010/0115459 A1
(43) Pub. Date: May 6, 2010

(54) METHOD, APPARATUS AND COMPUTER PROGRAM PRODUCT FOR PROVIDING EXPEDITED NAVIGATION

(75) Inventors: Jari Pekka Kinnunen, Helsinki (FI); Brenda Castro Pelayo, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 12/263,276

(22) Filed: Oct. 31, 2008

(51) Int. Cl. G06F 3/048

(52) U.S. Cl. 715/785

(57) ABSTRACT

An apparatus for providing expedited navigation may include a processor. The processor may be configured to generate an object indicative of a direction to a location of an item of interest associated with a content item, wherein the object comprises information associated with the item of interest. The processor may additionally be configured to provide for display of a portion of the content item and the object in a viewable area, wherein the item of interest is located outside the viewable area. The processor may further be configured to provide for automatic navigation of the content item to the location of the item of interest based at least in part on information associated with the object. Associated methods and computer program products may also be provided.

### TECHNOLOGICAL FIELD

Embodiments of the present invention relate generally to information service technology and, more particularly, relate to a method, apparatus and computer program product for providing expedited navigation.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Information provided to users may be based on location or otherwise be location-centric (e.g., location of family and/or friends, locations of interest such as shopping, entertainment, landmark, etc.). This type of information may be more meaningful if provided on a map. In some examples, information relating to the map may be presented to users via a display device. However, due to limitations associated with the size of the viewable portion of the display device, information desired by the user may be provided outside the viewable portion and may therefore not be visible to the user.

As such, for example, a user may be provided with arrows in a graphical user interface (GUI) to navigate the information presented. Thus, a user may access information outside the viewable portion by navigating or scrolling horizontally and/or vertically to, or zooming in/out and/or panning the map. As a further example, the user may switch between a map view to list or search view which are separately provided. However, this manual navigation process may be extensive and tedious. Moreover, switching between different views may be time consuming and confusing to the user, and therefore frustrate user experience.

Accordingly, it may be desirable to provide an improved mechanism for expedited navigation to access information located outside a viewable portion of a display device.

### BRIEF SUMMARY

A method, apparatus and computer program product are therefore provided to enable the provision of a mechanism for expediting navigation. In some exemplary embodiments, indicators may be provided to indicate a direction of at least one item of interest, associated with a content item, located outside the viewable area of a display. Attributes of the indicators (e.g., size, color, and/or the like) may be indicative of a distance to and timing information associated with their corresponding items of interest. As such, some exemplary embodiments of the invention may provide for seamless and automatic multidirectional navigation of the content item to the location of a selected item of interest.

In an exemplary embodiment, a method of providing expedited navigation is provided. The method may include generating an object indicative of a direction to a location of an item of interest associated with a content item, wherein the object comprises information associated with the item of interest. The method may also include providing for display of a portion of the content item and the object in a viewable area, wherein the item of interest is located outside the viewable area. The method may further include providing for automatic navigation of the content item to the location of the item of interest based at least in part on information associated with the object.

In another exemplary embodiment, a computer program product for providing expedited navigation is provided. The computer program product includes at least one computer-readable storage medium having computer-executable program code instructions stored therein. The computer-executable program code instructions may include program code instructions for generating an object indicative of a direction to a location of an item of interest associated with a content item, wherein the object comprises information associated with the item of interest. The computer-executable program code instructions may also include program code instructions for providing for display of a portion of the content item and the object in a viewable area, wherein the item of interest is located outside the viewable area. The computer-executable program code instructions may further include providing for automatic navigation of the content item to the location of the item of interest based at least in part on information associated with the object.

In another exemplary embodiment, an apparatus for providing expedited navigation is provided. The apparatus may include a processor. The processor may be configured to generate an object indicative of a direction to a location of an item of interest associated with a content item, wherein the object comprises information associated with the item of interest. The processor may also be configured to provide for display of a portion of the content item and the object in a viewable area, wherein the item of interest is located outside the viewable area. The processor may further be configured to provide for automatic navigation of the content item to the location of the item of interest based at least in part on information associated with the object.

In yet another exemplary embodiment, an apparatus for providing expedited navigation is provided. The apparatus may include means for generating an object indicative of a direction to a location of an item of interest associated with a content item, wherein the object comprises information associated with the item of interest. The apparatus may further include means for providing for display of a portion of the content item and the object in a viewable area, wherein the item of interest is located outside the viewable area. The apparatus may also include means for providing for automatic navigation of the content item to the location of the item of interest based at least in part on information associated with the object.

Embodiments of the invention may provide a method, apparatus and computer program product for employment, for example, in mobile environments. As a result, for example, mobile device users may enjoy an improved capability for expedited multidirectional navigation via their respective computing devices.

### BRIEF DESCRIPTION OF THE SEVERAL VIEWS OF THE DRAWING(S)

Having thus described some embodiments of the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates a block diagram of a mobile terminal according to an exemplary embodiment of the present invention;

FIG. 3 illustrates a schematic block diagram of an apparatus for providing expedited navigation according to an exemplary embodiment of the present invention;

FIG. 4 illustrates an example graphical representation of expedited navigation according to an exemplary embodiment of the present invention;

FIG. 5 illustrates another example of a graphical representation of expedited navigation according to an exemplary embodiment of the present invention;

FIG. 6 illustrates a further example of a graphical representation of expedited navigation according to an exemplary embodiment of the present invention;

FIG. 7 illustrates another example of a graphical representation of expedited navigation according to an exemplary embodiment of the present invention; and

FIG. 9 is a flowchart according to an exemplary method for providing expedited navigation according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Additionally, the terms “automatic” or “automatically” may be used interchangeably to refer to an action performed without user intervention. Likewise, “automatic navigation” or “automatic multidirectional navigation” may be used interchangeably to refer to navigation in an automated manner without user input (e.g., to a desired location) beyond the initial trigger, such as provided by a first user input requesting such navigation (e.g., associated with a directional indicator). Further, the terms “post” or “posting” may be used interchangeably to refer to adding content as in a blog or microblog. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Embodiments of the present invention may be employed in the context of expediting multidirectional navigation. In this regard, for example, a portion of a content item (e.g., map, media (e.g., image), multimedia, applications, and/or the like) may be provided on a viewable area of a display. One or more items of interests (e.g., user contact, gasoline stations, banks) associated with the content item may be provided outside and/or inside the viewable area. A selection of one or more selectable indicators associated with the item of interest may also be provided within the viewable area. The indicators may include information associated with the items of interest (e.g., identification, location, time information, communications, and/or the like). In some embodiments, the indicators may be directional indicators (e.g., arrows, pointing finger, signs, etc). Attributes such as, for example, size and color, may be associated with the indicators to indicate a distance to and a relevance of information (e.g., time information, type, and/or the like) associated with their corresponding items of interest. The indicators may be proximate to one or more edges of the viewable portion and may indicate the direction of one or more items of interest outside the viewable area. A user may thus select an indicator which may cause the portion of the content item in the viewable area to be automatically and/or seamlessly navigated, by zooming in/out, panning and/or jumping to a location of a corresponding item of interest. The navigation may be provided for a two dimensional environment or a three dimensional environment. As such, a user may efficiently and rapidly comprehend and access information located outside a viewable area, without having to manually navigate the content item or switch between multiple views, thereby enhancing user experience.

Although exemplary embodiments of the present invention may be described with respect to a map or a map view, other embodiments of the present invention may be equally applicable to other content items such as for example media (e.g., image), multimedia, applications, and/or the like.

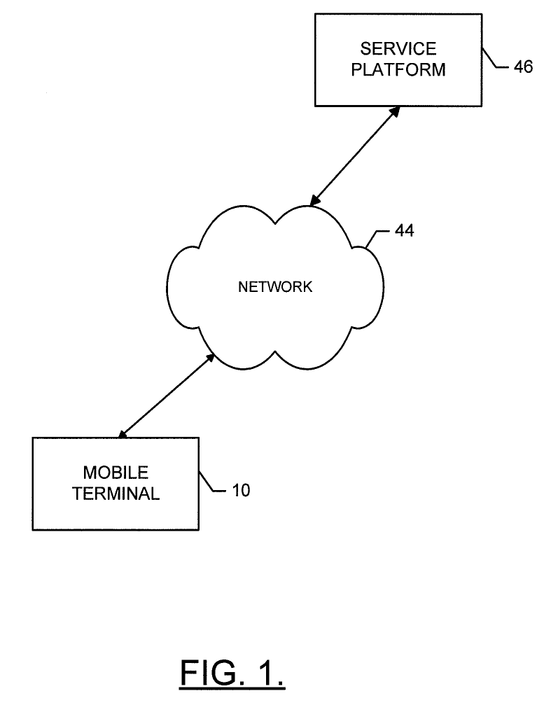

FIG. 1 illustrates a generic system diagram in which a device such as a mobile terminal 10, which may benefit from embodiments of the present invention, is shown in an exemplary communication environment. As shown in FIG. 1, an embodiment of a system in accordance with an example embodiment of the present invention may include a first communication device (e.g., mobile terminal 10) capable of communication with other devices via a network 44. In some cases, embodiments of the present invention may further include one or more additional communication devices and one or more network devices such as a service platform 46 with which the mobile terminal 10 may communicate to provide, request and/or receive information. In some embodiments, either or both of the mobile terminal 10 and the service platform 46 may include an apparatus 50 that may be configured to employ embodiments of the present invention. In this regard, it should be noted that the apparatus 50, which will be described in greater detail below, may be separately embodied at either one of the mobile terminal 10 or service platform 46 or at both of the mobile terminal 10 and the service platform 46 entirely or in a distributed manner. In an exemplary embodiment, if an instance of the apparatus 50 is embodied at both the mobile terminal 10 and the service platform 46, the apparatus 50 embodied at the mobile terminal 10 may comprise or execute a client application according to an exemplary embodiment, while the apparatus 50 embodied at the service platform 46 may include or comprise a server application according to an exemplary embodiment.

While several embodiments of the mobile terminal 10 may be illustrated and hereinafter described for purposes of example, other types of mobile terminals, such as portable digital assistants (PDAs), pagers, mobile televisions, mobile telephones, gaming devices, laptop computers, cameras, video recorders, audio/video player, radio, GPS devices, or any combination of the aforementioned, and other types of voice and text communications systems, can readily employ embodiments of the present invention. Furthermore, devices that are not mobile may also readily employ embodiments of the present invention.

The network 44 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 44. Although not necessary, in some embodiments, the network 44 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 may be in communication with each other via the network 44 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 via the network 44. By directly or indirectly connecting the mobile terminal 10 and other devices to the network 44, the mobile terminal 10 may be enabled to communicate with the other devices, for example, according to numerous communication protocols including Hypertext Transfer Protocol (HTTP) and/or the like, to thereby carry out various communication or other functions of the mobile terminal 10.

Furthermore, although not shown in FIG. 1, the mobile terminal 10 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 may be enabled to communicate with the network 44 and other devices by any of numerous different access mechanisms. For example, mobile access mechanisms such as wideband code division multiple access (WCDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 46 may be a device or node such as a server or other processing element. The service platform 46 may have any number of functions or associations with various services. As such, for example, the service platform 46 may be a platform such as a dedicated server (or server bank) associated with a particular information source or service (e.g., a location based service and/or a mapping service), or the service platform 46 may be a backend server associated with one or more other functions or services. As such, the service platform 46 may represent a plurality of different services or information sources. The functionality of the service platform 46 may be provided by hardware and/or software components configured to operate in accordance with known techniques for the provision of information to users of communication devices. However, some of the functionality provided by the service platform 46 may be information provided in accordance with embodiments of the present invention.

In an exemplary embodiment, the service platform 46 may represent a source for information associated with a service that may be provided to the mobile terminal 10 in accordance with embodiments of the present invention. As such, for example, the mobile terminal 10 may run a client application configured to communicate with a corresponding server function at the service platform 46. The client application may be configured to enable the registration to the service by a user of the mobile terminal 10, sending and receiving of request to and from one or more other users to be added as contact(s) on the service, uploading of contacts(s) from the mobile terminal 10 or another device (e.g., remote server), the activation and deactivation of location and/or content (e.g., messages, media, etc.) sharing, while the server function may enable the processing of these various requests and functionalities. The server platform 46 may then provide information associated with one or more user contacts and their associated locations to the mobile terminal 10 for display, and for seamless and automatic navigation.

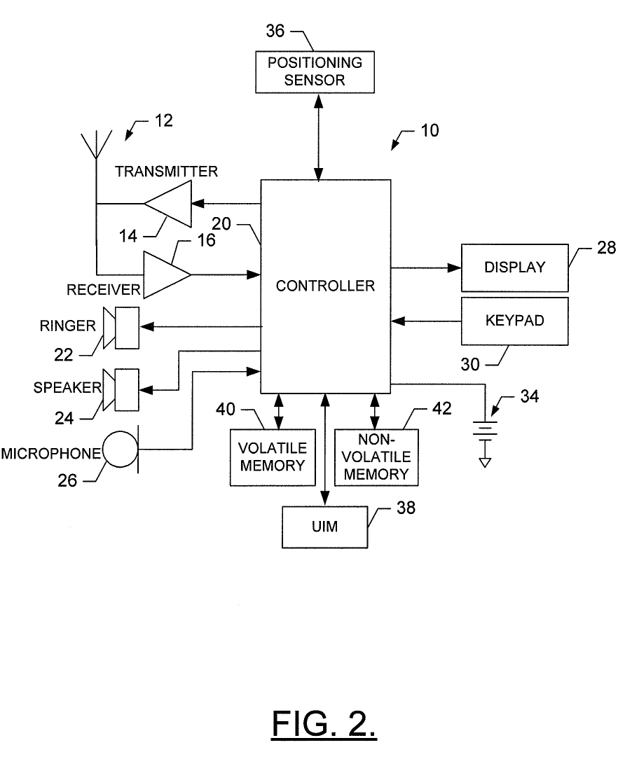

FIG. 2 illustrates a block diagram of a mobile terminal 10 that may benefit from embodiments of the present invention. It should be understood, however, that a mobile terminal as illustrated and hereinafter described is merely illustrative of one type of device that may benefit from embodiments of the present invention and, therefore, should not be taken to limit the scope of embodiments of the present invention.

The mobile terminal 10 may include an antenna 12 (or multiple antennas) in operable communication with a transmitter 14 and a receiver 16. The mobile terminal 10 may further include an apparatus, such as a controller 20 or other processing element, that may provide signals to and receive signals from the transmitter 14 and receiver 16, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

The controller 20 may include circuitry implementing, among others, audio and logic functions of the mobile terminal 10. For example, the controller 20 may comprise a digital signal processor device, a microprocessor device, and various analog to digital converters, digital to analog converters, and/or other support circuits. Control and signal processing functions of the mobile terminal 10 may be allocated between these devices according to their respective capabilities. The controller 20 may also support other functionality for use in encoding, receiving and/or transmitting messages. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 24, a ringer 22, a microphone 26, a display 28, and a user input interface, which may be coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 may further include a battery 34, such as a vibrating battery pack, for powering various circuits that are used to operate the mobile terminal 10, as well as optionally providing mechanical vibration as a detectable output.

The mobile terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. In addition to the UIM 38, the mobile terminal 10 may be equipped with memory. For example, the mobile terminal 10 may include volatile memory 40 and/or non-volatile memory 42.

In some cases, the mobile terminal 10 may further include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 may include a pedometer or inertial sensor. In this regard, the positioning sensor 36 may be capable of determining a location of the mobile terminal 10, such as, for example, longitudinal and latitudinal directions of the mobile terminal 10, or a position relative to a reference point such as a destination or start point. In some cases, the positioning sensor 36 may include components enabling a determination of mobile terminal 10 position based on triangulation with respect to signals received from various sources or other techniques. In some examples, the location of a mobile terminal 10 or a position relative to a reference point, such as a destination or start point, may be manually determined. Information from the positioning sensor 36 or manually determined may then, in some cases, be communicated to a memory of the mobile terminal 10 or to another memory device (e.g., associated with the server platform 46) to be stored as a position history or location information.

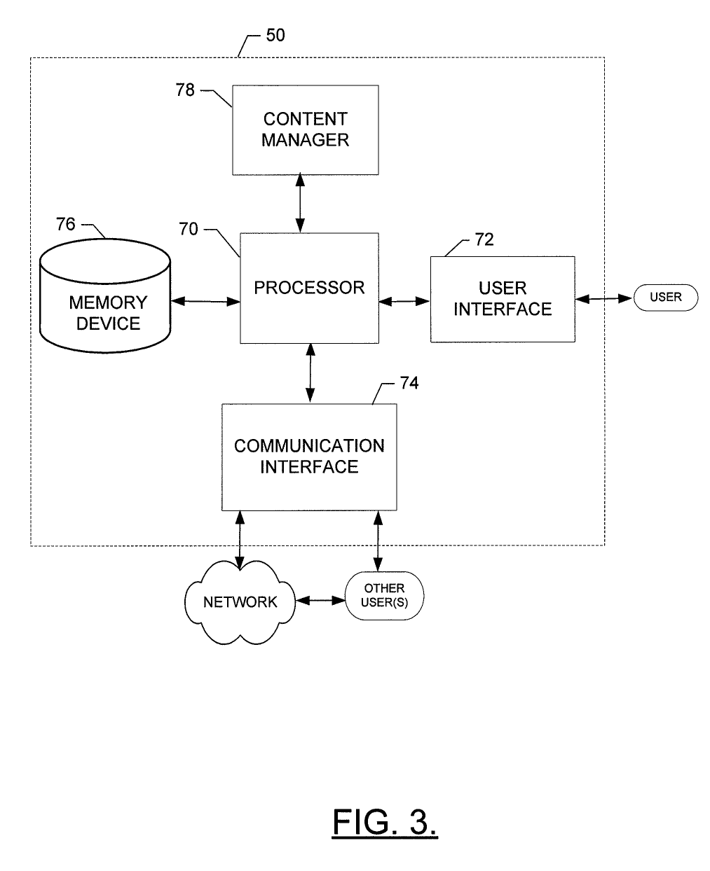

FIG. 3 illustrates a schematic block diagram of an apparatus for enabling the provision of expedited navigation according to an exemplary embodiment of the present invention. An exemplary embodiment of the invention will now be described with reference to FIG. 3, in which certain elements of an apparatus 50 for providing expedited multidirectional navigation are displayed. As indicated above, the apparatus 50 of FIG. 3 may be employed, for example, on the service platform 46 or on the mobile terminal 10. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the service platform 46 or the mobile terminal 10), by a plurality of devices in a distributed fashion (e.g., split between the service platform 46 and the mobile terminal 10) or by devices in a client/server relationship (e.g., the mobile terminal 10 and the service platform 46). Furthermore, it should be noted that the devices or elements described below may not be mandatory and thus some may be omitted in certain embodiments. Additional elements could also be added.

Referring now to FIG. 3, an apparatus for providing expedited multidirectional navigation is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information (e.g., information associated with user contact(s), preference(s) and/or profile(s) of user, etc., and/or the like), maps, information about various locations, services, etc., and/or the like) and/or media content. The information associated with user contact(s) may comprise identity(ies) of user(s), shared and unshared location(s) of user(s) and time associated with the location(s), shared and unshared event(s) associated with user(s) and time associated with the event(s) (e.g., a communication, the location (e.g., geographical) of creation of the communication, the time of creation), other shared or unshared information (e.g., media, applications, and/or the like), and/or the like.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied at a communication device (e.g., the mobile terminal 10), the user interface 72 may include, among other devices or elements, any or all of a speaker, a microphone, a display, and a keyboard or the like.

In an exemplary embodiment, the processor 70 may be embodied as, include or otherwise control a content manager 78. As such, the content manager 78 may in some cases be a separate device, module, or functional element. The content manager 78 may be any means such as a device or circuitry embodied in hardware, software or a combination of hardware and software (e.g., processor 70 operating under software control) that is configured to perform the corresponding functions of the content manager 78, as described below. For example, the content manager 78 may include means for generating an object indicative of a direction to a location of an item of interest associated with a content item, wherein the object comprises information associated with the item of interest, means for providing for display of a portion of the content item and the object in a viewable area, wherein the item of interest is located outside the viewable area, and means for providing for automatic navigation of the content item to the location of the item of interest based at least in part on information associated with the object.

In some embodiments, the content manager 78 may be configured to generate and/or display a content item or a portion thereof based at least in part on the size of a viewable area of a display. One or more items of interest, provided inside or outside the viewable area, may be associated with the content item. In some embodiments, the content item may be a media item, a multimedia item, an application, and/or the like. In other embodiments, the content item may be a map and therefore a map view of a particular area may be provided in the viewable area. As such, the items of interest may thus be points of interests (e.g., user contacts, gas stations, banks, and/or the like). Moreover, the map displayed may thus include one or more items of interest associated with the content item such as, for example, location(s) of user(s) and/or user contact(s), information associated with user(s) and/or user contact(s) (images, avatar, icons, communications, identifiers, other content, and/or the like), landmarks, roads, buildings, other points of interest, service points or numerous other geographical features.

The content manager 78 may be configured to generate and/or display indicators. In some examples, each indicator may be associated with a single item of interest of the content item. In other examples, each indicator may be assigned to a plurality of items of interest, all of which may be of a different kind of item of interest. The indicators may include information associated with the items of interest such as, for example, identification, locations and time associated with the locations, communications and time associated with the communications, and/or the like. For example, the information associated with an indicator corresponding to a user contact may comprise user contact identification (e.g., name, screen name, etc.), location of the user contact(s) (e.g., last known or shared location) and the time associated with the location (e.g., the time the location was stored and/or updated), event(s) associated with the user contact(s) (e.g., communications) and the time associated with the event(s) (e.g., time of posting and/or creation), shared content, and/or the like. As used herein, “event” or “activity” may be used interchangeably to refer to creating a communication on the apparatus 50. As used herein, “communication” may be used to refer to a message or a posted message. In some embodiments, a type of message (e.g., message post) may be associated with a creator of the message, the content thereof, and the time of posting and/or creation. Another type of message (e.g., a location-stamped post) may also be associated with a creator of the message, the content thereof, the location (e.g., geographical) of the user or user contact when the message was posted and/or created, and the time of posting and/or creation. In some embodiments, the content manager 78 may cause a location validity attribute to be associated with the messages. For example, a user may associate a predetermined location or a geographical area surrounding or otherwise associated with the location wherein the associated message may be accessed (e.g., viewable or visible). As such, the content manager 78 may cause the navigation to be based at least in part on the location of creation of the message and/or the location validity attribute associated with the message. The content manager 78 may also be configured to generate and/or display icons or representations associated with these types of messages. The content of the location-stamped posts, message posts, and the comments thereto may be accessible. For example, the content manager 78 may receive a user input (e.g., a click on a selected post or comment) and cause the post or comment to be opened for review

In some embodiments, the indicators may be directional indicators (e.g., arrows, pointing finger, signs, and/or the like). The indicators may be displayed proximate to one or more edges of the viewable portion and may indicate the direction of one or more items of interest outside the viewable area. In a three dimensional environments, the indicators may be skewed in perspective to accordingly indicate three dimensional directions. The indicators may be provided in left, right, down, and up orientations but also diagonal and/or other orientations. The content manager 78 may be configured to determine and/or update, and associate attributes with the indicators such as, for example, the size and/or the color of the indicators. In some embodiments, the size of the indicator may be based at least in part on the location of the item of interest and/or the distance to that the location. The distance to the item of interest may be based at least in part on a reference location (e.g., a starting point such as, for example, the current location of the user of the mobile terminal, the location of an item of interest currently in focus on in the viewable area, and/or the like). In some examples, the reference location may be the current location of the user of the mobile terminal, while in other examples, the reference location may be the location of an item of interest (e.g., an item of interest currently in focus on in the viewable area). The color of the indicator may be indicative of relevant information associated with the item of interest based at least in part on (e.g., time information associated with the item of interest, a type of the item of interest, and/or the like). For example, a first color (e.g., green) may indicate that the time associated with the location of the item of interest and/or an event of the item of interest may be recent. A second color (e.g., gray) may indicate that the time associated with the location of the item of interest and/or an event of the item of interest may not be recent. As a further example, a first color may indicate a type of item of interest (e.g., user contact, sports or fitness center, public transportation, and/or the like).

The content manager 78 may be configured to provide a multidirectional navigation of the content item. In this regard, for example, the content manager 78 may be configured to provide a zoom on, a pan in and/or a jump to a desired location independently of a selected indicator in a conventional navigational manner or provide an automatic navigation based at least in part on the information associated with a selected indicator. The information associated with the selected indicator may be the location of the item of interest. For example, the content manager 78 may receive a selection of an indicator from a user which may subsequently cause the portion of the content item in the viewable area to be automatically and/or seamlessly navigated, such as by zooming in/out, panning and/or jumping to a location of a corresponding item of interest based at least in part on the information associated with the selected indicator (e.g., the location of the item of interest). As such, the item of interest may be provided for display inside the viewable area. In some examples, the content manager 78 may receive a selection of an indicator from a user which may provide the re-centering of an item of interest, even if the item of interest was originally provided in the viewable area (e.g., an item of interest originally provided in off-centered position in the viewable area may be brought to the center of the viewable area following the navigation). In other examples, the content manager 78 may receive a selection of an indicator from a user which may subsequently cause the portion of the content item in the viewable area to be automatically and/or seamlessly navigated, by jumping (e.g., without a pan but in a single motion) to a location of a corresponding item of interest, which location may be far away from the reference location. In some cases, the navigation may be uninterrupted by further user input until arriving to the location of the corresponding item of interest. In some embodiments, the indicator associated with the displayed item of interest may disappear following such navigation. In some cases, the navigation may be interrupted. In some examples, a different portion of the content item may be provided for display inside the viewable area following the navigation. One or more indicators provided on the previous portion of the content item may also disappear and correspondingly, one or more additional indicators may be provided for display depending upon the relative location of the items of interest with respect to the portion of the content provided in the viewable area.

A user may navigate via the selection of indicators via various user input interface(s) and/or device(s) associated with or supported by the mobile terminal such as, for example, a keyboard, a multidirectional button, a joystick, a mouse, and/or the like. As such, a user may navigate the selection of indicators by moving left, right, up, down, diagonally, and/or in a three dimension fashion when in a three dimensional environment. For example, a user may navigate with a multidirectional button and click once on a directional indicator (e.g., up arrow) and thus select to move the viewable portion of the content item to include the item of interest that is associated with the directional indicator selected by the user, based at least in part on the location of the item of interest. Accordingly, the content manager 78 may receive the single input and navigate the content item (e.g., northward) to an item of interest whose associated location may be closest to the directional indicator previously clicked on by the user. The item of interest closest may be determined by identifying the item of interest whose location is the closest to a reference location, in the direction indicated by the directional indicator or within a certain angle of the direction indicated by the directional indicator. Similarly, a second user input (e.g., down key) may select move the viewable portion of the content item to include the item of interest that is associated with the directional indicator selected by the user, based at least in part on the location of the item of interest and/or the current location of the user, or the current location of a user contact in focus. Accordingly, the content manager 78 may receive the input and navigate the content item (e.g., downward) to an item of interest whose associated location may be closest to the directional indicator previously clicked on by the user. The content manager 78 may also cause the return to a previous viewable area of the portion of the content item and its associated previous indicators by receiving a user input request such action. As such, upon return to the previous portion, a second click of the user upon the same directional indicator (e.g., up key) may cause the closest item of interest in the selected direction to be skipped and to, instead, move to an associated item of interest that may be the next closest to the directional indicator selected by the user, based at least in part on the location of the item of interest. The content manager 78 may also be configured to receive inputs from the other user input interfaces listed above and navigate the content item. In some examples, the mobile terminal may be associated with a motion sensor such as, for example, an accelerometer device. As such, the indicators may be selected based at least in part on the motion of the mobile terminal. For example, the user may desire to access an item of interest in a certain direction (e.g., left) and thus move the mobile terminal in a desired direction (e.g., left). The content manager 78 may receive the input from the motion sensor indicating a movement to the left and navigate the content item (e.g., to the left) to an item of interest whose associated location may be closest and/or farthest in the desired direction.

The content manager 78 may also be configured to periodically monitor the location of a user or user contact (e.g., other users registered with the service platform 46 and/or added as contacts to the user or otherwise associated with the user) based at least in part on the use of the client application of the server platform 46. For example, positioning data (e.g. positioning sensor 36 data, cellid, etc.) may be monitored more periodically (e.g., every two seconds) if the application is being actively used (e.g., foreground use), or less periodically (e.g., every three, fifteen or thirty minutes) if the application is being passively used (e.g., background use). New position data may be recorded and/or updated more periodically (e.g., every two seconds) on a mobile terminal 10, and less periodically on the server platform 46 (e.g., every three, fifteen or thirty minutes), thereby allowing the location of a user or user contact to be accessed by other users or user contacts.

In some embodiments, the content manager 78 may be further configured to include routing services. For example, the content manager 78 may be configured to determine one or more candidate routes between a current or starting location and a destination or ending location based on any known route determination methods. As such, for example, the content manager 78 may provide route guidance based at least in part on multiple locations associated with one or more particular items of interest, or provide route guidance to a particular service point, landmark, building, point of interest, etc., using operational information such as driving time, driving distance, fuel consumption, battery consumption, etc. The content manager 78 may incorporate into the map display various ones of the geographical features and other supplemental information about a particular service point (e.g., an identifier or icon indicative of the availability of a particular product or service (e.g., gasoline or food)).

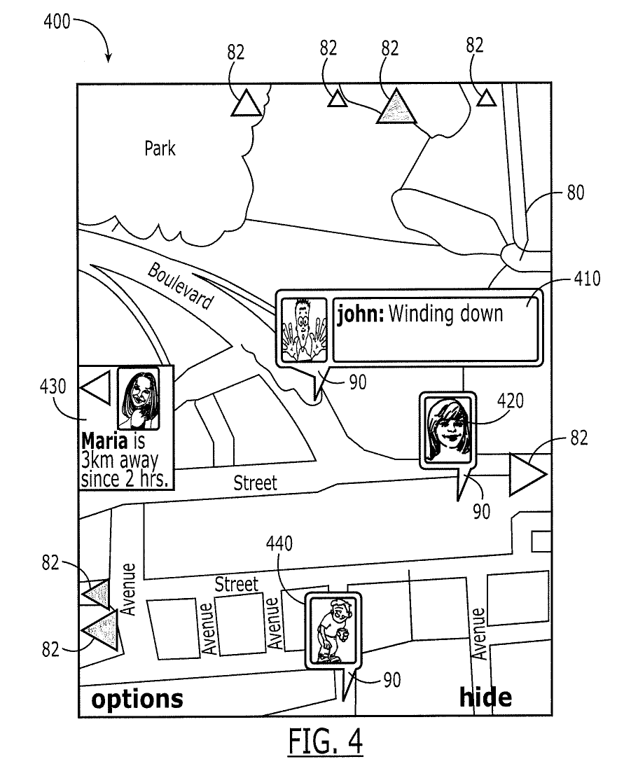

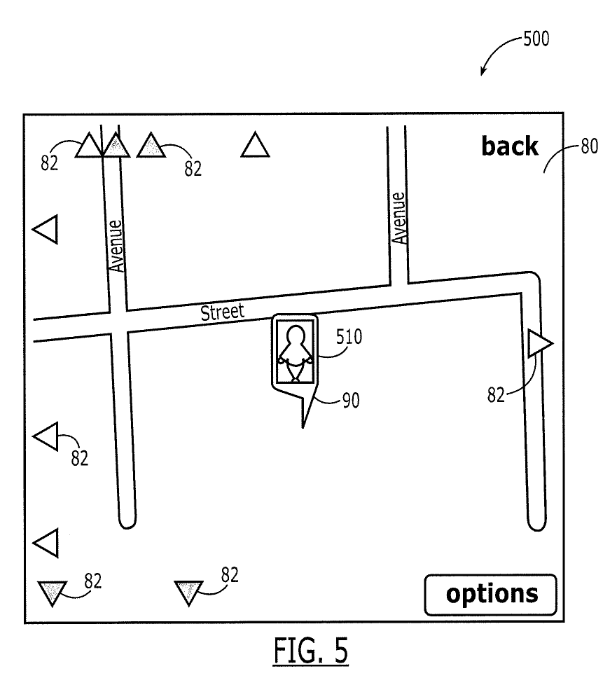

FIG. 4 illustrates an example graphical representation of expedited navigation according to an exemplary embodiment of the present invention. As shown FIG. 4, a content item may be provided for display in a viewable area 400. In some embodiments, the viewable area 400 may only display a portion of the content item. The content item may be a map 80 and as such, the viewable area 400 may provide a map view. The map 80 may include a plurality of items of interests (410-440), which may be representative of the current or most recent location of the items of interest (e.g., user contacts). The map 80 may also include indicators 82 of various sizes. The indicators 82 may be directional indicators (e.g., arrows) indicative of a direction to a location of items of interest that may not be provided for display in the viewable area 400. The size of the indicator may be based at least in part on the location of the item of interest and/or the distance to that the location. The distance to the item of interest may be based at least in part on a reference location (e.g., the current location of the user of the mobile terminal, the location of an item of interest currently in focus on in the viewable area, and/or the like). The size of the indicator may vary proportionately (or inversely proportionately) to the distance from the reference location to the location of interest. In some examples, the bigger the indicators, the farther away the corresponding items of interest may be, while in other examples, the bigger the indicators, the closer the corresponding items of interest may be. Indicators may have other characteristics (color, blink, rate, texture, etc.) that may be indicative of respective attributes of the associated item of interest. For example, the indicators may also be of different colors. The colors may be based at least in part on a relevance of information associated with the item of interest (e.g., time information). For example, a first color (e.g., green) may indicate that the time associated with the location of the item of interest and/or an event associated with the item of interest may be recent (e.g., the event may have occurred within a predetermined time limit such as, for example, three, five, ten, thirty minutes). A second color (e.g., gray) may indicate that the time associated with the location of the item of interest and/or an event associated with the item of interest may not be recent (e.g., the event may have occurred above a predefined time limit). In some embodiments, the colors may be based at least in part on a status of the item of interest. For example, a first color may be associated with the indicators to indicate that the status of the corresponding items of interest is active, and a second color may be associated with the indicators to indicate that the status of the corresponding items of interest is inactive. As such, a user may easily ascertain information associated with the items of interest outside the viewable area 400, and thus not visible, based at least in part on the size and/or other characteristics (e.g., the color of the indicator corresponding to the item of interest).

A user may thus decide to view one or more items of interest outside the viewable area 400 by selecting one or more indicators using, for example, various user input interface(s) and/or device(s) associated with or supported by the mobile device such as, for example, a keyboard, a joystick, a mouse, and/or the like. In some embodiments, the navigation of the content item may be substantially simultaneous to the selection of the indicators, while in other embodiments, the navigation of the content item may be slightly delayed (e.g., half a second, a second, etc.). A user may select the indicators via various user input interface(s) and/or device(s) associated with or supported by the mobile terminal such as, for example, a keyboard, a multidirectional button, a joystick, a mouse, and/or the like. As such, the indicators may be selected to move left, right, up, down, diagonally, and/or in a three dimension fashion when in a three dimensional environment. For example, a user may navigate with a keyboard or multidirectional button. As such, each directional input (e.g., clicking on a directional indicator) may select an indicator whose associated item of interest may be closest to the directional indicator selected by the user, based at least in part on the location of the item of interest. Accordingly, for example, a user may click on the up arrow key and the content item may be navigated (e.g., northward) to an item of interest whose associated location may be closest to the directional indicator previously clicked on by the user. In some embodiments, the user may desire to return to the screen previous view (e.g., providing a previous portion of the content item) from the current one be providing an input indicating such (e.g., e.g., depressing a button). As another example, a user may navigate with a touch pad or a mouse and as such may directly access the indicator without input constraints, as may be the case of navigation with a keyboard and/or the like.

Upon selecting an indicator, the content item may be automatically and/or seamless navigated, by zooming in/out, panning and/or jumping to a location of a corresponding item of interest based at least in part on the information associated with the selected indicator (e.g., the location of the item of interest). As such, the item of interest may be provided for display in the form of an avatar, an image, a descriptive icon or other character representing the item of interest. In some examples, the selected item of interest may be the focus of the viewable area following such navigation. In some embodiments, the indicator associated with the displayed item of interest may disappear following such navigation. In some examples, a different portion of the content item may be provided for display inside the viewable area following such navigation. One or more indicators provided on the previous portion of the content item may also disappear and correspondingly, one or more additional indicators may be provided for display depending upon the relative location of items of interests with respect to the portion of the map provided in the viewable area. Similarly, one or more items of interest provided on the previous portion of the content item may also disappear following such navigation. These one or more items of interest may be replaced by one or more indicators indicative of a direction to their location on the content item depending upon the relative location of items of interests with respect to the portion of the map provided in the viewable area. Correspondingly, one or more additional items of interest may be provided for display in the viewable area following such navigation.

Some items of interests (e.g., 410) may include an identifier of the item of interest (e.g., a name or screen name) and an event associated with the item of interest (e.g., a message post) and/or the time associated with the message. The items of interest may also include the location and/or the time associated with the location (e.g., the time the last known location was recorded). Some items of interests (e.g., 420 and 440) may only provide the representation of the item of interest (e.g., avatar, image, icon, and/or the like). In some embodiments, a relevance of information attribute (e.g., time information, type, etc.) may be associated with the items of interest (e.g., 410-440) to indicate whether the location and/or an event associated with the item of interest is recent (e.g., the event occurred within a predetermined amount of time). For example, a freshness indicator 90 may be placed around the user contact representation. For example, a first color of the freshness indicator 90 may indicate that the location and/or event associated with the user contact is recent, while a second color may indicate that the location and/or event associated with the user contact is old or not recent. The freshness indicator 90 may include gradations to represent a range of time values. As such, a user may readily identify an active item of interest. In some embodiments, one or more indicators may be provided for display, including information associated with their corresponding items of interest. For example, an indicator may be provided for display along with at least some of the information associated with the indicator pertaining to the item of interest such as, for example, an identifier of the item of interest, a representation of the item of interest, the location and/or the distance of the item of interest (from a reference location), a time associated with the location of the item of interest and/or an event associated with the item of interest. As shown, indicator 430 may be provided along additional information regarding the corresponding item of interest, such as for example, the name of the item of interest (Maria), an avatar, the distance of the interest (3 km away), the time the last known location was recorded and/or updated (2 hours ago). In some embodiments, this additional information may be provided with one or more indicators based at least in part on a randomized fashion, clockwise fashion of the viewable area, time associated with the location or an event associated with the item of interest, a change of status of the item of interest (e.g., inactive to active, and vice versa), and/or the like. The additional information may also be provided based at least in part on a user input such as, for example, a mouseover input, a slight mouse click input, a touch input (e.g., on a surface with a touch sensor), and/or the like.

FIG. 5 illustrates an example graphical representation of expedited navigation according to an exemplary embodiment of the present invention. As shown FIG. 5, a content item may be provided for display in a viewable area 500. In some embodiments, the viewable area 500 may only display a portion of the content item. The content item may be a map 80 including a plurality of indicators 82, which may be directional indicators (e.g., arrows), of various sizes and/or colors. FIG. 5 may illustrate the result of a user selecting an indicator associated with item of interest 500, which may represent a user contact. In this regard, the viewable area 500 may be focused and/or centered on item of interest 510. The freshness indicator 90 may indicate that the item of interest 510 is active (e.g., a recent location and/or recent event). The directional indicator corresponding to the item of interest 510 may have indicated that the item of interest 510 may have been active (e.g., based on the color of the indicator). As such, there may a correspondence and/or match between an attribute (e.g., color) of the indicator and the attribute (e.g., color) of the freshness indicator of the item of interest. However, in some examples there may not be a match. For example, an indicator may indicate the item of interest is inactive but the item of interest may become active during the navigation process to the location of the item of interest. As shown, the representation of the item of interest may be a default representation. Nevertheless, the representation may be personalized to clearly identify and distinguish one item of interest from another.

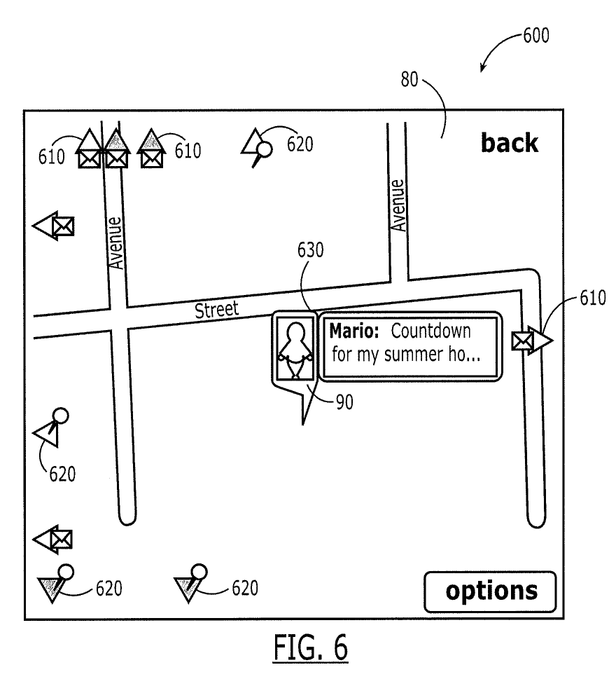

FIG. 6 illustrates an example graphical representation of expedited navigation according to an exemplary embodiment of the present invention. As shown in FIG. 6, a content item may be provided for display in a viewable area 600. In some embodiments, the viewable area 600 may only display a portion of the content item. The content item may be a map 80 including a plurality of indicators 610 and 620 (e.g., directional indicators) of various sizes and/or colors. As shown, different embodiments of indicators may be provided. Some embodiments of the indicators may include an icon or a representation of location-stamped post (e.g., 620) and other embodiments may include an icon or a representation of a message post (e.g., 610). The additional icons or representations may provide further information in addition to the indication of location or distance (e.g., size of the indicator) and/or the relevance of information (e.g., color of the indicator which may be associated with time information), such as, for example, one or more events associated with the items of interest. In this regard, in some examples, a directional indicator may be provided with a message post icon (e.g., an envelope icon) which may indicate that the associated item of interest has posted message (e.g., a user contact has written or posted a message). As such, for example, a user may desire to access (e.g., read) the message associated with the item of interest. The user may thus select the indicator which may cause the content item to be automatically and/or seamless navigated, by zooming in/out, panning and/or jumping to a location associated with the message post. The user may therefore access the message post (e.g., by clicking on the pin). In some examples, the location associated with the message post may correspond to the last known location of the item of interest. In this regard, in some examples, a directional indicator may be provided with a location-stamp post icon (e.g., a pin icon) which may indicate that the associated item of interest has a location-stamped post associated therewith. For example, the item of interest may have generated a location-stamped post to comment on a current location (e.g., recommending a restaurant, a particular site). In some examples, a location-stamped post may quickly be generated with a generic or default message (e.g., “I'm here”) to indicate the current location of the user to other user(s), without the user drafting a specific message. As such, for example, a user may desire to access (e.g., read) the location-stamp post associated with the item of interest. The user may thus select the indicator which may cause the content item to be automatically and/or seamless navigated, by zooming in/out, panning and/or jumping to a location associated with the location-stamp post. The user may therefore access the location-post (e.g., by click on the pin). In some examples, the location associated with the location-stamped message may correspond to the location associated with the message, without corresponding to the last known location of the item of interest as the item of interest may have moved to a different location. In some cases, navigating to a location associated with the event may comprise navigating to the location of creation of the event and/or the location validity associated with the event, as discussed above. In other cases, the message may available for access upon navigating to the location associated with the message without requiring any user input. In other examples, item of interest 630, which may represent a user contact, has posted a status message indicating a countdown for an aspect of his summer. A user may select an indicator which may cause the focus of the viewable area 600 to change. As a result, item of interest 630 may be removed from the viewable area and its corresponding indicator, pointing to the direction of the location of the item of interest 630, may include a message post icon. Some indicators may not be provided with a message post icon or a location-stamp post icon, as illustrated in the previous figures. It may be an indication that the item of interest may not have an event associated therewith, or that a previously associated event was removed (e.g., the message status may have been cleared or the location-stamp post may have been deleted).

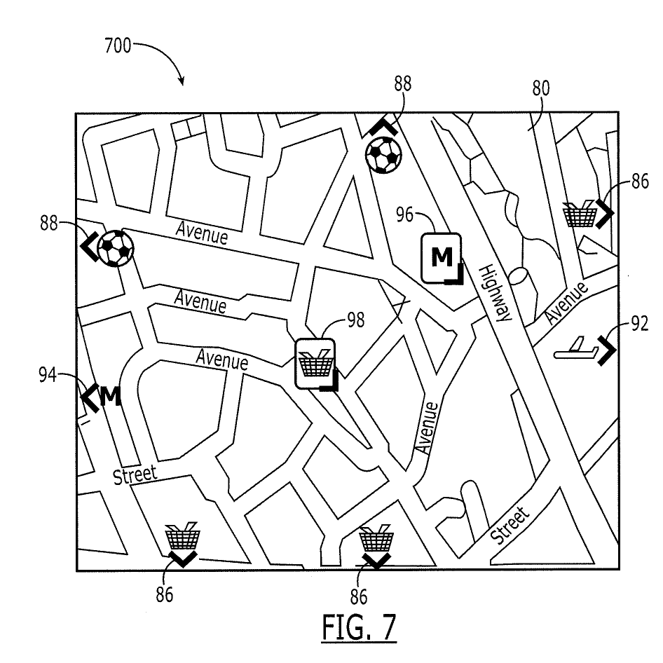

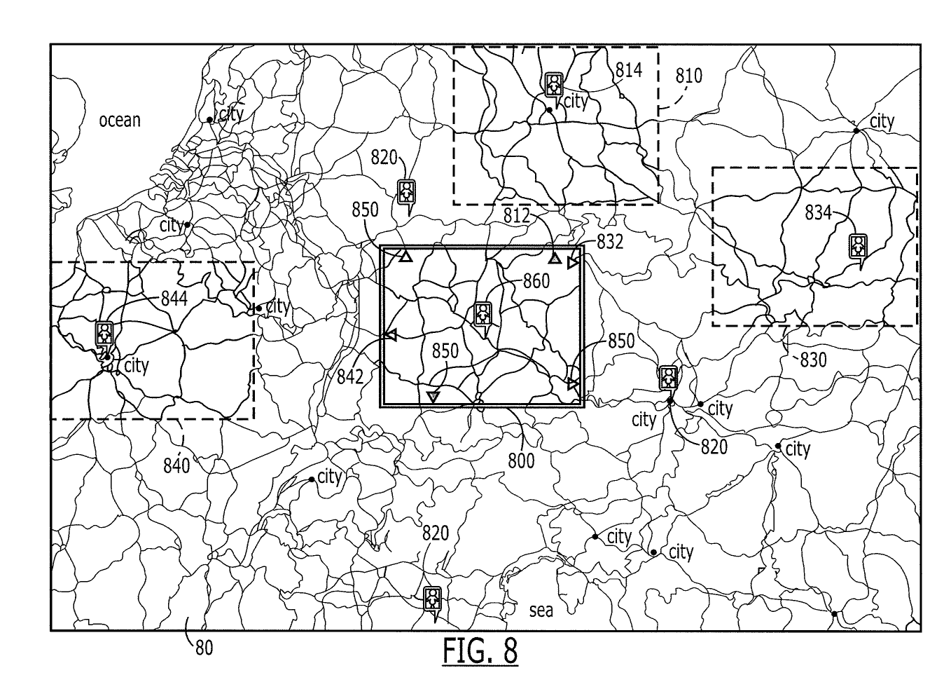

FIG. 7 illustrates an example graphical representation of expedited navigation according to an exemplary embodiment of the present invention. As shown FIG. 7, a content item may be provided for display in a viewable area 700. In some embodiments, the viewable area 700 may only display a portion of the content item. The content item may be a map 80 including a plurality of items of interests (96 and 98) and indicators (86, 88, 92, and 94) (e.g., directional indicators) of various sizes and/or colors. As shown, different items of interests may be identified. In some embodiments, the items of interest may be representative of points of interests and/or service points, such as, for example, shopping centers (98), sports or fitness centers, airports, public transportations (96), gasoline stations, landmarks, and/or the like. Similarly, different embodiments of indicators may also be provided. The indicators may be directional indicators coupled with representations of points of interest, services, and/or the like. As such, additional information regarding items of interest outside the viewable area 700 may provided to the user. In addition to the attributes discussed above (e.g., size), the indicators may also include representation of points of interest, service points, and/or the like. For example, indicators 86 may be indicative of shopping centers in their respective directions, indicators 88 may be indicative of sports or fitness centers, indicator 92 may be indicative of an airport, and indicator 94 may be indicative of public transportation. In some examples, the indicators may be customized to share the same relevance of information attribute (e.g., color). As such, the indicators sharing the same attribute (e.g., color) may be indicative of corresponding items of interest of the same or similar kind. For example, all the sports or fitness centers may be of a same color. In some embodiment one or more types or category of items of interest (e.g., sports centers, restaurants, shopping centers, and/or the like) may be selected to be provided for display to the exclusion of all other indicators not within the category. As such, only the indicators corresponding to the one or more categories may be provided for display. For example, a user may desire to view a particular item of interest (e.g., a particular shopping center, airport, sports center, etc.). The user may thus select the indicator which may cause the content item to be automatically and/or seamless navigated, by zooming in/out, panning and/or jumping to the location of the item of interest.

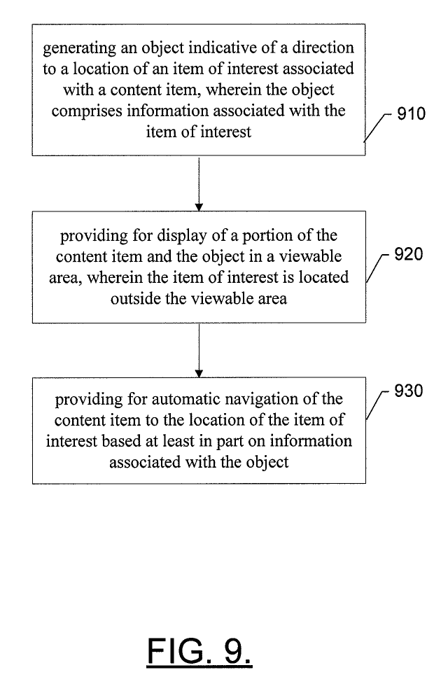

FIG. 9 is a flowchart of a system, method and program product according to some exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, service platform or other apparatus employing embodiments of the present invention and executed by a processor in the mobile terminal, service platform or other apparatus. As will be appreciated, any such computer program instructions may be loaded onto a computer or other programmable apparatus (i.e., hardware) to produce a machine, such that the instructions which execute on the computer (e.g., via a processor) or other programmable apparatus create means for implementing the functions specified in the flowchart block(s) or step(s). These computer program instructions may also be stored in a computer-readable memory that can direct a computer (e.g., the processor or another computing device) or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing expedited navigation as illustrated, for example, in FIG. 9 may include generating an object indicative of a direction to a location of an item of interest associated with a content item, wherein the object may include information associated with the item of interest at operation 810. The method may further include providing for display of a portion of the content item and the object in a viewable area, wherein the item of interest is located outside the viewable area at operation 820. The method may additionally include providing for automatic navigation of the content item to the location of the item of interest based at least in part on information associated with the object.

In some embodiments, certain ones of the operations above may be modified or further amplified as described below. It should be appreciated that each of the modifications or amplifications below may be included with the operations above either alone or in combination with any others among the features described herein. In this regard, for example, generating an object indicative of a direction to an item of interest at operation 810 may include associating the object with at least one of a first attribute based at least in part on a distance to the location of the item of interest or a second attribute based at least in part on a status of the item of interest. Alternatively or additionally, generating an object indicative of a direction to a location of an item of interest at operation 810 may include generating an object including information associated with at least one user contact selected from the group consisting of user contact identification, location, activity, and time of an activity associated with the at least one user contact. In some examples, providing for display of the object at operation 820 may include providing for display of at least a portion of the information associated with the item of interest. In other examples, providing for display of a portion of the content item in a viewable area at operation 820 may include providing for display of a portion of a map in the viewable area.

In an exemplary embodiment, providing for automatic navigation to the location of the item of interest at operation 830 may include automatically navigating to the location of the item of interest in response to receiving a user input associated with the object. In another exemplary embodiment, generating an object indicative of a direction to a location of an item of interest at operation 810 may include generating a directional indicator indicating a direction to the location of the item of interest. In some cases, generating a directional indicator indicating a direction to the location of the item of interest may include determining a size of the directional indicator indicating a distance to the location of the item of interest and a color of the directional indicator indicating timing information associated with the item of interest.

In an exemplary embodiment, an apparatus for performing the method of FIG. 9 above may comprise a processor (e.g., the processor 70) configured to perform some or each of the operations (810-830) described above. The processor may, for example, be configured to perform the operations (810-830) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 810-830 may comprise, for example, the processor 70, the content manager 78, or an algorithm executed by the processor for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
generating an object indicative of a direction to a location of an item of interest associated with a content item, wherein the object comprises information associated with the item of interest;
providing for display of a portion of the content item and the object in a viewable area, wherein the item of interest is located outside the viewable area; and
providing for automatic navigation of the content item to the location of the item of interest based at least in part on information associated with the object.

2. The method of claim 1, wherein generating an object indicative of a direction to an item of interest comprises associating the object with at least one of a first attribute based at least in part on a distance to the location of the item of interest or a second attribute based at least in part on a status of the item of interest.

3. The method of claim 1, wherein generating an object indicative of a direction to a location of an item of interest comprises generating a directional indicator indicating a direction to the location of the item of interest.

4. The method of claim 3, wherein generating a directional indicator indicating a direction to the location of the item of interest comprises determining a size of the directional indicator indicating a distance to the location of the item of interest and a color of the directional indicator indicating timing information associated with the item of interest.

5. The method of claim 1, wherein providing for automatic navigation to the location of the item of interest comprises automatically navigating to the location of the item of interest in response to receiving a user input associated with the object.

6. The method of claim 1, wherein generating an object indicative of a direction to a location of an item of interest comprises generating an object including information associated with at least one user contact selected from the group consisting of user contact identification, location, activity, and time of an activity associated with the at least one user contact.

7. The method of claim 1, wherein providing for display of the object comprises providing for display of at least a portion of the information associated with the item of interest.

8. The method of claim 1, wherein providing for display of a portion of the content item in a viewable area comprises providing for display of a portion of a map in the viewable area.

9. A computer program product comprising at least one computer-readable storage medium having computer-executable program code instructions stored therein, the computer-executable program code instruction comprising:
program code instructions for generating an object indicative of a direction to a location of an item of interest associated with a content item, wherein the object comprises information associated with the item of interest;
program code instructions for display of a portion of the content item and the object in a viewable area, wherein the item of interest is located outside the viewable area; and
program code instructions for providing for automatic navigation of the content item to the location of the item of interest based at least in part on information associated with the object.

10. The computer program product of claim 9, wherein program code instructions for generating an object indicative of a direction to an item of interest includes program instructions for associating the object with at least one of a first attribute based at least in part on a distance to the location of the item of interest or a second attribute based at least in part on a status of the item of interest.

11. The computer program product of claim 9, wherein the program code instructions for generating an object indicative of a direction to a location of an item of interest includes program code instructions for generating a directional indicator indicating a direction to the location of the item of interest.

12. The computer program product of claim 11, wherein the program code instructions for generating a directional indicator indicating a direction to the location of the item of interest includes program code instructions for determining a size of the directional indicator indicating a distance to the location of the item of interest and a color of the directional indicator indicating timing information associated with the item of interest.

13. The computer program product of claim 9, wherein the program code instructions for providing for automatic navigation to the location of the item of interest includes program code instructions for automatically navigating to the location of the item of interest in response to receiving a user input associated with the object.

14. The computer program product of claim 9, wherein program code instructions for generating an object indicative of a direction to a location of an item of interest includes program code instructions for generating an object including information associated with at least one user contact selected from the group consisting of user contact identification, location, activity, and time of an activity associated with the at least one user contact.

15. The computer program product of claim 9, wherein program code instructions for providing for display of the object includes program code instructions for providing for display of at least a portion of the information associated with the item of interest.

16. The computer program product of claim 9, wherein program code instructions for providing for display of a portion of the content item in a viewable area includes program code instructions for providing for display of a portion of a map in the viewable area.

17. An apparatus comprising a processor configured to:
generate an object indicative of a direction to a location of an item of interest associated with a content item, wherein the object comprises information associated with the item of interest;
provide for display of a portion of the content item and the object in a viewable area, wherein the item of interest is located outside the viewable area; and
provide for automatic navigation of the content item to the location of the item of interest based at least in part on information associated with the object.

18. The apparatus of claim 17, wherein the processor configured to generate an object indicative of a direction to an item of interest comprises the processor configured to associate the object with at least one of a first attribute based at least in part on a distance to the location of the item of interest or a second attribute based at least in part on a status of the item of interest.

19. The apparatus of claim 17, wherein the processor configured to generate an object indicative of a direction to a location of an item of interest comprises the processor configured to generate a directional indicator indicating a direction to the location of the item of interest.

20. The apparatus of claim 19, wherein the processor configured to generate a directional indicator indicating a direction to the location of the item of interest comprises the processor configured to determine a size of the directional indicator indicating a distance to the location of the item of interest and a color of the directional indicator indicating timing information associated with the item of interest.

21. The apparatus of claim 17, wherein the processor configured to provide for automatic navigation to the location of the item of interest comprises the processor configured to automatically navigate to the location of the item of interest in response to receiving a user input associated with the object.

22. The apparatus of claim 17, wherein the processor configured to generate an object indicative of a direction to a location of an item of interest comprises the processor configured to generate an object including information associated with at least one user contact selected from the group consisting of user contact identification, location, activity, and time of an activity associated with the at least one user contact.

23. The apparatus of claim 17, wherein the processor configured to provide for display of the object comprises the processor configured to provide for display of at least a portion of the information associated with the item of interest.

24. The apparatus of claim 17, wherein the processor configured to providing for display of a portion of the content item in a viewable area comprises the processor configured to provide for display of a portion of a map in the viewable area.

25. An apparatus comprising:
means for generating an object indicative of a direction to a location of an item of interest associated with a content item, wherein the object comprises information associated with the item of interest;
means for providing for display of a portion of the content item and the object in a viewable area, wherein the item of interest is located outside the viewable area; and
means for providing for automatic navigation of the content item to the location of the item of interest based at least in part on information associated with the object.

26. The apparatus of claim 25, wherein means for generating an object indicative of a direction to a location of an item of interest comprises means for generating a directional indicator indicating a direction to the location of the item of interest, the means for generating a directional indicator comprising means for determining a size of the directional indicator indicating a distance to the location of the item of interest and a color of the directional indicator indicating timing information associated with the item of interest.

27. The apparatus of claim 26, further comprising means for updating at least one of the size of the directional indicator based at least in part on the distance to the location of the item of interest or the color of the directional indicator based at least in part on a status of the item of interest
